(19) United States
(12) Patent Application Publication
(10) Pub. No.: US 2026/0018981 A1
(43) Pub. Date: Jan. 15, 2026

(54) ELECTROMAGNETIC DEVICE

(71) Applicants: KOGAKUIN UNIVERSITY, Tokyo (JP); DAIFUKU CO., LTD., Osaka (JP)

(72) Inventor: Mimpei MORISHITA, Tokyo (JP)

(21) Appl. No.: 18/870,106

(22) PCT Filed: May 29, 2023
(86) PCT No.: PCT/JP2023/019960

§ 371 Date: Sep. 12, 2025

(30) Foreign Application Priority Data
May 27, 2022 (JP) 2022-087258

(51) Int. Cl. H02K 33/12; H02K 41/02

(52) U.S. Cl. CPC H02K 33/12; H02K 41/02

(57) ABSTRACT

In an electromagnetic device, a field system section, including plural permanent magnets arrayed such that a magnetization direction is changed in sequence each time by a setting angle θ arrayed to give an array length that is a natural number of times a length of one cycle of magnetic poles, is disposed facing an armature section capable of relative movement. In the armature section, coils of each phase are arrayed in sequence, and are connected such that similar current is flowed in each of the coils of the same phase. In the electromagnetic device, even if a change in a distribution of magnetic flux linking with coils occurs at an end portion along the movement direction of the field system section, an end effect in which this change appears in some coils can be suppressed, enabling thrust ripple caused by the end effect to be effectively suppressed.

### CROSS-REFERENCE TO RELATED APPLICATIONS

This application is a U.S. national stage filing under 35 U.S.C. § 371 of International Application No. PCT/JP2023/019960 filed on May 29, 2023, which claims priority to and the benefit of Japanese Patent Application No. 2022-087258, filed on May 27, 2022, entitled ELECTROMAGNETIC DEVICE, both of which are incorporated herein by reference in their entirety.

### TECHNICAL FIELD

Technology disclosed herein relates to a moveable magnet type of electromagnetic device that moves a field system with respect to an armature coil.

### BACKGROUND ART

A linear motor described in Japanese Patent Application Laid-Open (JP-A) No. 2003-209963 includes field poles having a Halbach array structure. In this linear motor, first main magnetic poles are arranged at the two ends of a yoke of field poles that moves relative to an armature, second main magnetic poles are arranged at positions excluding the two ends of the yoke, first sub-magnetic poles are arranged between the first main magnetic poles and the second main magnetic poles, and second sub-magnetic poles are arranged between the second main magnetic poles.

Moreover, in this linear motor the width of the first main magnetic poles is narrower than the width of the second main magnetic poles, and the width of the first sub-magnetic poles is wider than the width of the second sub-magnetic poles.

### SUMMARY OF INVENTION

### Technical Problem

However, in the linear motor described above, permanent magnets are required that not only have different magnetization directions but also have different widths, in order to suppress the influence of end effect in a Halbach array.

In consideration of the above circumstances, an object of the present invention is to provide an electromagnetic device capable of effectively suppressing thrust ripple caused by the end effect.

### Solution to Problem

In order to address the above issue, an electromagnetic device of a first aspect includes: a field system section in which a plurality of permanent magnets are arrayed on a moving body moved relatively in a length direction of an elongated fixed body, the plurality of permanent magnets being arrayed such that a magnetization direction is changed in sequence each time by an angle resulting from dividing one cycle of electric angles corresponding to one cycle of magnetic poles by a division number n to give an array length that is a natural number of times a length of the one cycle of electric angles along a movement direction of the moving body, wherein the division number n is any integer of three or more; and an armature section provided to the fixed body, the armature section including a plurality of sets of armature coils that are arrayed in the length direction of the fixed body within a movement range of the moving body with one set being a number of phases worth of armature coils, and that are fed with power such that the same current is flowed in each of the armature coils of the same phase.

In the electromagnetic device of the first aspect, the moving body is moved relative to the fixed body. An opening section is disposed in the moving body. Plural permanent magnets are arrayed in the field system section, such that the magnetization direction is changed in sequence, each time by the angle resulting from dividing one cycle of electric angles corresponding to one cycle of magnetic poles by the division number n, to give the array length that is a natural number of times (an integer of one or more times) the length of the one cycle of electric angles (one cycle of magnetic poles) along the movement direction of the moving body, wherein the division number n is any integer of three or more.

The armature section is disposed on the fixed body and includes the plural sets of armature coils that are arrayed in the armature section in the length direction of the fixed body within the movement range of the moving body with one set being a number of phases worth of armature coils. The armature coils are arrayed over the entire movement range of the field system section moved together with the moving body, and the moving body can be moved together with the field system section by thrust generated between the armature coil and the field system section due to a prescribed alternating power being supplied to the armature coils of plural phases.

A configuration is adopted for the armature coils of each phase such that the same current is flowed in each of the armature coils of the same phase. To do this, the armature coils of the same phase may be connected together in series, or power may be supplied such that the same current is flowed in each of the armature coils of the same phase. This means that, even if a change in a distribution of magnetic flux linking with armature coils occurs at movement direction end portions (both end portions) of the field system section, this change may be suppressed from appearing in some armature coils, enabling thrust ripple caused by an end effect to be effectively suppressed.

An electromagnetic device of a second aspect includes: a field system section in which a plurality of permanent magnets are arrayed on a moving body moved relatively in a length direction of an elongated fixed body, the plurality of permanent magnets being arrayed such that a magnetization direction is changed in sequence each time by an angle resulting from dividing one cycle of electric angles corresponding to one cycle of magnetic poles by a division number n to give an array length that is a natural number of times a length of the one cycle of electric angles along a movement direction of the moving body, wherein the division number n is any integer of three or more; and an armature section provided to the fixed body, the armature section including a plurality of sets of armature coils that are arrayed in the length direction of the fixed body within a movement range of the moving body with one set being a number of phases worth of armature coils; and a power supply section that supplies power to each of the armature coils such that the same current is flowed in each of the armature coils of the same phase, when supplying power to each of the armature coils of the armature section and moving the moving body.

An electromagnetic device of a third aspect, in the first aspect, further includes a power supply section that supplies power to each of the armature coils such that the same current is flowed in each of the armature coils of the same phase when moving the moving body.

An electromagnetic device of a fourth aspect, in the second or third aspect, for the armature coils in a range of the moving body linked by magnetic flux from the field system section, the power supply section supplies power such that the same current is flowed in each of the armature coils of the same phase.

An electromagnetic device of a fifth aspect, in any one of the second aspect to the fourth aspect, for the armature coils in a range of a length of half a cycle worth with respect to the one cycle of magnetic poles from each of two ends of the array of permanent magnets, the power supply section supplies power such that the same current is flowed in each of the armature coils of the same phase.

An electromagnetic device of a sixth aspect, in the fourth or fifth aspect, further including a detection means, provided to the fixed body facing the field system section, that detects magnetic flux to detect the permanent magnet array, and the power supply section supplies power to the armature coils according to a detection result of the detection means.

An electromagnetic device of a seventh aspect, in any one of the first aspect to the sixth aspect, a length Lc of an array of one set of the armature coils is configured as a natural number of times a length Lm of the one cycle of magnetic poles of the permanent magnets.

An electromagnetic device of an eighth aspect, in any one of the first aspect to the sixth aspect, a length of the array of the armature coils in the armature section is configured as a natural number of times a length Lc of the array of the armature coils of one set.

An electromagnetic device of a ninth aspect, in any one of the first aspect to the eighth aspect, the field system section includes a first magnet array and a second magnet array each arrayed with the plural permanent magnets, and the first magnet array and the second magnet array arranged facing each other such that magnetic fields formed by each other are reinforced with the armature coils interposed therebetween.

An electromagnetic device of a tenth aspect, in any one of the first aspect to the eighth aspect, a ferromagnetic material is disposed in the armature section in an array range of the plural armature coils, at an opposite side of the armature coils to the field system section.

### Advantageous Effects of Invention

An electromagnetic device according to technology disclosed herein exhibits the excellent effect of being able to suppress thrust ripple caused by an end effect using current flowing in armature coils, and so enables thrust ripple caused by the end effect to be effectively suppressed.

### BRIEF DESCRIPTION OF DRAWINGS

FIG. 1A is a schematic configuration diagram illustrating main parts of an example of an electromagnetic device according to the present exemplary embodiment.

FIG. 1B is a schematic configuration diagram illustrating a magnetic flux density distribution in the electromagnetic device of FIG. 1A.

FIG. 2 is a schematic configuration diagram illustrating main parts and a magnetic flux density distribution of an electromagnetic device with a Halbach magnet array applied to the electromagnetic device of FIG. 1A.

FIG. 3A is a graph schematically illustrating changes in magnetic flux density with respect to position of one cycle worth of magnetic poles of a magnet array.

FIG. 3B is a graph illustrating an example of changes in voltage due to back electromotive force in the electromagnetic device of FIG. 1A.

FIG. 3C is a graph illustrating an example of torque change in the electromagnetic device of FIG. 1A.

FIG. 4A is a schematic configuration diagram illustrating main parts and a magnetic flux density distribution of another example of an electromagnetic device according to the present exemplary embodiment.

FIG. 4B is a schematic configuration diagram illustrating main parts and a magnetic flux density distribution of an electromagnetic device which a dual Halbach magnet array applied to the embodiment described of FIG. 4A.

FIG. 5 is a perspective view schematically illustrating a conveyance device according to a first example.

FIG. 6 is a cross-section looking along a length direction and illustrating main parts of a conveyance device.

FIG. 7 is a cross-section looking along a width direction and illustrating main parts of a conveyance device.

FIG. 8 is a block diagram illustrating a schematic configuration of main parts of a drive device.

FIG. 9 is a block diagram illustrating a schematic configuration of an electric angle detection unit.

FIG. 10 is a block diagram illustrating a schematic configuration of a coil energizing unit.

FIG. 11 is a perspective view schematically illustrating a vibration device according to a second example.

FIG. 12 is a cross-section looking along a length direction and illustrating main parts of a vibration device.

FIG. 13 is a plan view of main parts of a vibration device.

### DESCRIPTION OF EMBODIMENTS

Detailed description follows regarding an exemplary embodiment of the present disclosure, with reference to the drawings.

Multi-phase alternating power having two or more phases is applied to an electromagnetic device according to the present exemplary embodiment. The electromagnetic device includes a field system section arrayed with plural permanent magnets, and an armature section arrayed with armature coils for a number of phases corresponding to the alternating current power. The electromagnetic device has the armature section disposed on a fixed body, and has the field system section disposed on a moving body. In the electromagnetic device, a length of an array of armature coils in the armature section is made longer than a length of a magnet array in the field system section. Within a range of the length of the armature coil array in the electromagnetic device, a thrust generated between the armature coils and the permanent magnets functions as a drive force to move the moving body (movement in one direction or reciprocating movement).

Note that the electromagnetic device can function as a generator to generate electrical power in the armature coils by the moving body being moved. Description follows regarding an example of an electromagnetic device that functions as a drive source in various moving devices or the like. Moreover, in the technology disclosed herein, reference to being the same, in addition to being the same shape, size, numerical value, change in numerical value, etc., also includes a range of shape, size, numerical value, change in numerical value, etc. viewed as being the same, and the following description will refer to being similar, which includes being the same.

### Halbach Array Field System (Single Halbach Array Field System)

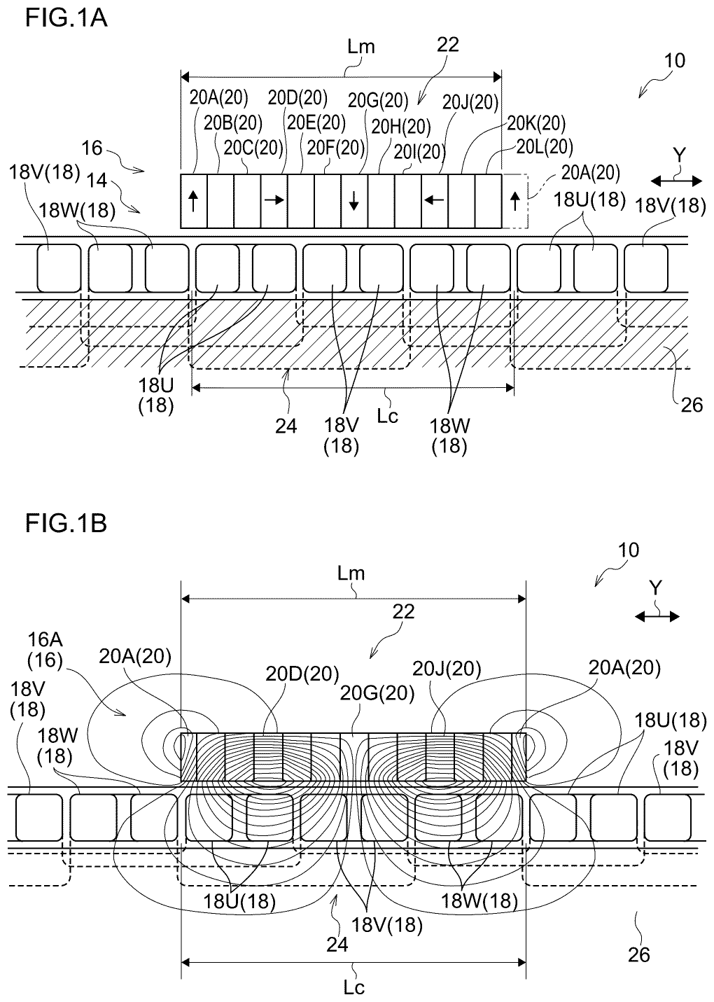

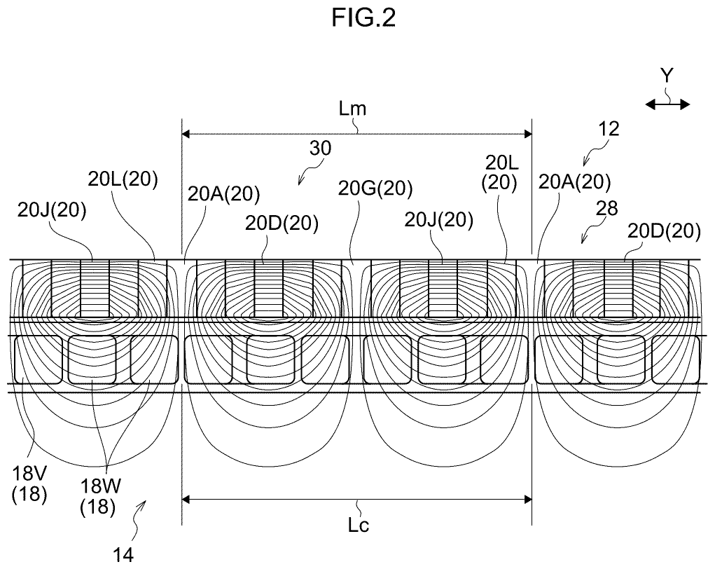

FIG. 1A and FIG. 1B are schematic configuration diagrams illustrating main parts of an electromagnetic device 10 according to the present exemplary embodiment, and FIG. 2 is a schematic configuration diagram illustrating main parts of an electromagnetic device 12 corresponding to the electromagnetic device 10. Note that in the following description an array direction of permanent magnets and armature coils is taken as a thrust direction, with the thrust direction (also referred to as movement direction) indicted by arrow Y in the drawings. Moreover, FIG. 1B illustrates a distribution of lines of magnetic force (magnetic flux density distribution) of the electromagnetic device 10, and FIG. 2 illustrates a distribution of lines of magnetic force (magnetic flux density distribution) of the electromagnetic device 12.

As illustrated in FIG. 1A, the electromagnetic device 10 includes an armature section 14 disposed on a fixed body, and a field system section 16 disposed on a moving body facing the armature section 14. In the electromagnetic device 10, plural armature coils (hereafter referred to as coils) 18 are disposed in the armature section 14, and plural permanent magnets 20 are disposed in the field system section 16, with the coils 18 and the permanent magnets 20 each arrayed along the thrust direction.

Moreover, in the electromagnetic device 10, a length of the armature section 14 along the thrust direction (overall length of the coil 18 array) is longer than the length of the field system section 16 (overall length of the permanent magnet 20 array). Thus, in the electromagnetic device 10, within the range of the array of plural coils 18 in the armature section 14, the field system section 16 moves relatively along the array direction (thrust direction) of the plural coils 18. Note that the array direction of the plural coils 18, which is the thrust direction, is not limited to being a direction along a flat plane, and also includes a direction along a circular arc shaped curved surface, however, for simplicity of explanation, the following description is of a thrust direction that is a direction along a flat plane.

The permanent magnets 20 of the field system section 16 are each configured with similar external diameter shapes (sizes), and with similar cross-section profiles when sectioned along the thrust direction and along an up-down direction (a direction intersecting with a plane along the thrust direction, a top to bottom direction in the page) (hereinafter simply referred to as cross-section profiles). The permanent magnets 20 are each configured with a rectangular shaped cross-section profile. Note that, in the following description, similar includes being the same shape, size, etc. as well as being similar enough to be viewed as being the same. Moreover, the permanent magnets 20 are not limited to having rectangular shaped cross-section profiles, and other shapes may be applied therefor as long as a similar shape is employed for all the plural permanent magnets 20 according to attachment to the moving body, the thrust direction, and the like including, for example, triangular shapes such as an equilateral triangular shape, a trapezoidal shape, a fan shape, a circular shaped profile, and the like.

In the field system section 16, a Halbach magnet array is applied as the array for the permanent magnets 20. In the Halbach magnet array, a setting angle θ is an angle resulting from dividing one cycle of electric angles (2π=360°) corresponding to one cycle of magnetic poles (two magnetic poles worth) by a division number n, wherein the division number n is an integer of three or more. In the Halbach magnet array, the permanent magnets 20 are arrayed such that a magnetization directions is changed in sequence by the setting angle θ each time. Note that the magnetization direction is a direction from an S pole to an N pole inside (within the cross-section) of the permanent magnet 20 (a direction indicated by an arrow in each of the permanent magnets 20 of FIG. 1A).

In the field system section 16, as an example, the division number n=12 and the setting angle θ is 30° (θ=30°). In the field system section 16, a length Lm is a length of one cycle worth of magnetic poles corresponding to one cycle of electric angles in the array direction of the permanent magnet 20, and there are 12 individual permanent magnets 20A to 20L arrayed in sequence within a range of length Lm so as to form a permanent magnet array 22. This means that for two magnetic poles in the permanent magnet array 22, the setting angle θ (=30°) is the angle formed between magnetization directions of mutually adjacent permanent magnets 20. Note that, the field system section 16 may be configured by arraying one or plural of the permanent magnet arrays 22, such that the field system section 16 is formed with an overall array direction length that is a natural number of times (integer of one or more times) a length Lc.

In the field system section 16, due to configuration as a Halbach magnet array, the magnetic field on one side in a direction intersecting with the array direction of the permanent magnets 20 is suppressed (weakened), and the magnetic field on the other side thereof is strengthened compared to the magnetic field on the one side. The side with the strengthened magnetic field in the field system section 16 is set as the armature section 14 side.

In the electromagnetic device 10, multi-phase power is employed as alternating power, and two phases or three phases or more may be applied as the number of phases of the alternating power. As an example, three-phase alternating power is employed in the electromagnetic device 10. A set of coils 18 for each phase (a U-phase coil 18U, a V-phase coil 18V, and a W-phase coil 18W) are arranged as a coil array 24, with plural of the coil arrays 24 arranged in the armature section 14. Litz wire is employed for windings in the coils 18, with each of the coils 18 being an air-core coil (may be an air-core from a magnetic perspective).

In the armature section 14, the coils 18 (18U, 18V, 18W) are each arrayed at a prescribed gap spacing, with the plural coil arrays 24 arranged on a support body 26 arrayed along the thrust direction. In the armature section 14, a length Lc of one cycle of electric angles corresponds to a length of one set of coils 18U to 18W (one coil array 24). Note that the length Lc of one cycle of electric angles is a length (distance) between gap intermediate positions between a given coil array 24 and the coil arrays 24 on each side of the given coil array 24, and is a length from a gap center position between one coil 18W and one coil 18U, to a gap center position between the next coil 18W and next coil 18U.

As illustrated in FIG. 2, the electromagnetic device 12 corresponds to the electromagnetic device 10, and the electromagnetic device 12 includes the armature section 14 and a field system section 28 facing the armature section 14. In the field system section 28, a single set of magnet array (corresponding to the permanent magnet array 22) is configured by permanent magnets 20A to 20L having magnetization directions shifted in sequence by a specific setting angle θ, with plural of these sets arrayed along the thrust direction. This means that an ordinary Halbach array field system longer than the field system section 16 is applied as the field system section 28.

In the field system section 28, focusing on a single set of permanent magnets 20A to 20L and on a permanent magnet 20A adjacent to the permanent magnet 20L, a distance (length) between an intermediate position of one permanent magnet 20A in this array and an intermediate position of the other permanent magnet 20A is a length Lm of one cycle of magnetic poles. Taking this portion as a magnet array 30, the field system section 28 is a Halbach magnet array in which, in a range of each of the magnet arrays 30, the amount of flux interlinkage linked to the coils 18 changes in a sine wave shape. This means that the field system section 28 provided with the plural arrays of the permanent magnets 20A to 20L (corresponding to the permanent magnet array 22) is configured arrayed with plural of the magnet arrays 30.

FIG. 1B illustrates a field system section 16A in which the permanent magnet array 22 of the field system section 16 in the electromagnetic device 10 has been replaced with the magnet array 30. Note that in FIG. 1B, the permanent magnet 20A is divided in half in the array direction length, and each of the divided permanent magnets 20A arranged at the respective two ends in the array direction, so as to give one cycle of magnetic poles length Lm.

As illustrated in FIG. 1B, in the field system section 16A, the magnetic flux density distribution at the periphery of the permanent magnets 20A at the array direction two ends of the magnet array 30 differs from the magnetic flux density distribution at the array direction two ends of the magnet array 30 for a case in which a Halbach magnet array (field system section 28) is applied. In the field system section 16A, the difference in the magnetic flux density distributions at the array direction two ends of the magnet array 30 causes an end effect to occur in the electromagnetic device 10.

However, combining two of the magnet arrays 30 results in a magnetic flux density distribution between the two magnet arrays 30 similar to that of a Halbach magnet array (the magnet arrays 30 in the field system section 28) due to the principle of superposition in electromagnetism.

In the electromagnetic devices 10, 12, the one cycle of magnetic poles length Lm and the one cycle of electric angles length Lc are the same (Lm=Lc). In the electromagnetic devices 10, 12, the start point and the end point of one cycle of magnetic poles of the magnet array 30 are assumed to be in a state matching the start point and the end point of one cycle of electric angles of the coil array 24.

Focusing on a coil 18U in such a situation, in the field system section 28 configured by a Halbach magnet array, back electromotive force generated in the coil 18U by the magnetic flux density distribution of the one cycle of magnetic poles of the magnet array 30 changes in a sine wave shape. The voltage between winding start and winding end of the coil 18U depends on a vector sum of magnetic flux of the one cycle of magnetic poles of the magnet array 30.

In contrast thereto, in the field system section 16A, magnetic flux of the permanent magnet 20A at one end of the magnet array 30 interlinkages with the coil 18U of the coil array 24 facing the magnet array 30, and the magnetic flux of the permanent magnet 20A at the other end of the magnet array 30 interlinkages with the coil 18U of the coil array 24 adjacent to the coil array 24 facing the magnet array 30.

This means that, in the field system section 16A, the magnetic flux density distribution of the one cycle of magnetic poles of the magnet array 30 generates back electromotive force in the coil 18U of the coil array 24 facing the magnet array 30 and in the coil 18U of the coil array 24 adjacent to the coil array 24 facing the magnet array 30. Moreover, in one cycle worth of magnetic poles of the magnet array 30 in the field system section 28, a vector sum of magnetic flux at the one end of the magnet array 30 matches a vector sum of magnetic flux at the other end of the magnet array 30.

When the two coils 18U, which are the coil 18U of the coil array 24 facing the magnet array 30 and the coil 18U of the coil array 24 adjacent to the coil array 24 facing the magnet array 30, are connected together in series, the magnet array 30 generates a back electromotive force in the two coils 18U that changes in a sine wave shape. When this occurs, for example, by connecting the winding end of the coil 18U of the coil array 24 facing the magnet array 30 to the winding start of the coil 18U adjacent to the coil array 24 facing the magnet array 30, a voltage between the winding start of the coil 18U of the coil array 24 facing the magnet array 30 and the winding end of the coil 18U adjacent to the coil array 24 facing the magnet array 30 depends on the vector sum of magnetic flux of one cycle of magnetic poles of the magnet array 30.

Namely, in the field system section 16A a sum of an amount of flux interlinkage linking with the two coils 18U due to the magnet array 30 is similar to the amount of flux interlinkage linking with a single coil 18U by the single magnet array 30 of the field system section 28. This means that, in the field system section 16A, the sum of voltages generated in the two coils 18U linked by the magnetic flux from the magnet array 30 is equivalent to the voltage generated in the single coil 18U linked by the magnetic flux from the single magnet array 30 in the field system section 28.

Thus as illustrated in FIG. 1A and FIG. 1B, in the electromagnetic device 10 the plural coils 18U are accordingly electrically connected together in series along the thrust direction (array direction) (indicated by the broken lines in FIG. 1A and FIG. 1B). This means that, in the field system section 16A (similarly to in the field system section 16), the connection points between adjacent coils 18U in the plural coils 18U are at the same potential. In the permanent magnet array 22 (the magnet array 30) of the electromagnetic device 10, the end effect can be suppressed from occurring in the coils 18U of the U-phase, similarly to the magnet arrays 30 in the field system section 28 applied with a Halbach magnet array.

The effect due to the magnet array 30 of the field system section 16A is similarly exhibited in the permanent magnet arrays 22 of the field system section 16. Moreover, the above configuration established in the coils 18U of one of the phases can similarly be applied to the configurations of the coils 18V, 18W of the other phases, enabling generation of an end effect to also be suppressed in the V-phase coils 18V and in the W-phase coils 18W.

This means that, in the electromagnetic device 10, generation of the end effect can be suppressed by configuring such that the coils 18 of the same phase can be viewed as being electrically connected together in series, such that the same current flows in the coils 18 of the same phase in the multi-phase coil array 24 configured with the one cycle of electric angles length Lc with respect to the one cycle of magnetic poles length Lm of the permanent magnet arrays 22. The end effect can also be suppressed from occurring even in cases in which the length of the field system section 16 is an integer number of times (positive integer number of times) the length Lm, and the length of the armature section 14 is an integer number of times (positive integer number of times) the length Lc.

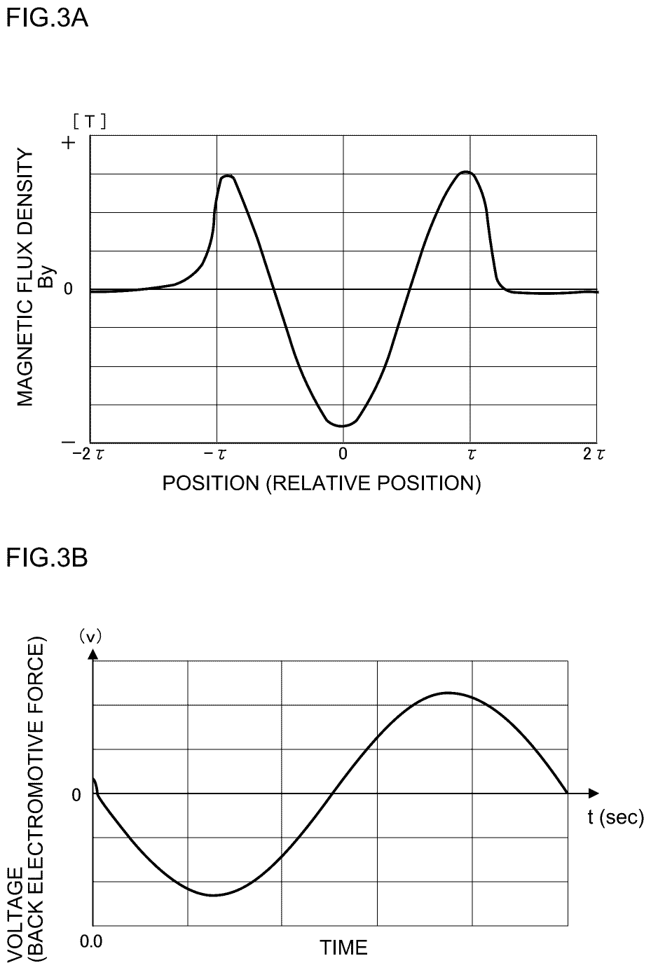

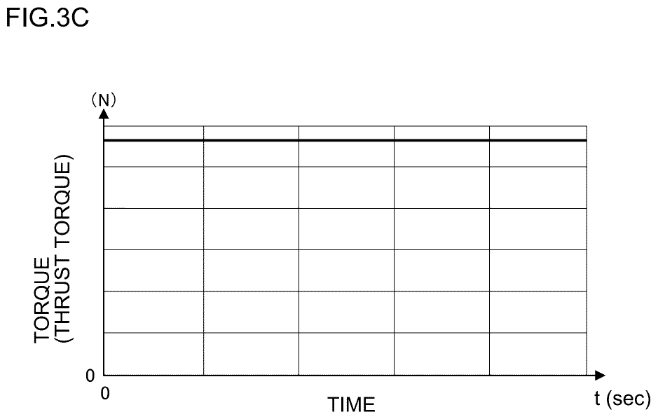

FIG. 3A is a graph schematically illustrating changes in a magnetic flux density By for a magnet array of one cycle worth of magnetic poles (corresponding to the permanent magnet array 22) illustrated in FIG. 1B along a magnet array approach/separation direction at a face on the magnet array side of the coil 18. Note that in FIG. 3A, a position on the face on the magnet array side of the coil 18 (relative position with respect to the magnet array) is shown on the horizontal axis (x axis), and a direction from the coils 18 toward the magnet array is shown on the vertical axis (y axis). Moreover, in FIG. 3A, ½ of the one cycle of magnetic poles length Lm is a length τ (τ=Lm/2), a point corresponding to a center position of the magnet array is point 0 on the horizontal axis, and magnetic flux density (T) is shown on the vertical axis.

As illustrated in FIG. 3A, in the magnet array of length Lm, the magnetic flux density is large at the center position and at each of the two ends in the array direction. Moreover, in a space above the coils 18, magnetic flux leakage occurs in a range from position t away from the magnet array end to position 2τ and in a range from position −2τ to position −τ, and the magnetic flux density is not 0[T]. This magnetic flux leakage is a cause of the generation of the end effect in the electromagnetic device 10.

However, FIG. 3B is a graph illustrating, as a voltage change, changes in the electromagnetic device 10 in back electromotive force generated by the one cycle worth of magnetic poles of permanent magnet array 22 (similarly for the magnet array 30) in the coils 18, FIG. 3C is a graph illustrating changes in torque (thrust torque) occurring between the permanent magnet array 22 and the coil 18. Note that time(s) is shown on the horizontal axis in FIG. 3B and FIG. 3C, voltage (V) is shown on the vertical axis of FIG. 3B, and torque (thrust torque) (N) is shown on the vertical axis of FIG. 3C. Moreover, voltage change and torque change are respectively illustrated in FIG. 3B and FIG. 3C with respect to time when the permanent magnet array 22 is moved at a specific speed relative to the coil 18.

In a conveyance device (linear motor) with the electromagnetic device 10 as a drive source, the field system section 16 moves in the direction of (or parallel to) the moving magnetic field formed by the flow of multi-phase (three-phase) alternating current in each of the coils of the multiple phases (for example three phases). Generally, the amount of flux interlinkage linking with a single coil facing a Halbach array field system changes in a sine wave shape due to relative movement between the coils and the field system.

This means that in the electromagnetic device 10, the amount of flux interlinkage linking with each of the coils 18 (18U, 18V, 18W) accompanying relative movement of the permanent magnet array 22 changes in a sine wave shape. Thus, as illustrated in FIG. 3B, in the electromagnetic device 10, back electromotive force generated in the coils 18 has a sine wave shape with harmonic components suppressed (not containing harmonic components). Moreover, in the electromagnetic device 10, as illustrated in FIG. 3C, ripple is suppressed from occurring in the thrust generated between the permanent magnet array 22 and the coil 18 by excitation current flowing in the coils at the same frequency as the sine wave shape of the back electromotive force occurring in each of the coils 18. In the electromagnetic device 10, the generation of the end effect can accordingly be suppressed, enabling (generation of) thrust ripple caused by the end effect to be effectively suppressed.

Such an effect of the electromagnetic device 10 is not limited to when the magnet array length in the field system section 16 is the one cycle of magnetic poles length Lm, and the magnet array length may be a natural number of times (integer of one or more times) the one cycle of magnetic poles length Lm. Moreover, the effect of the electromagnetic device 10 should be achieved when the array length of the coils 18 in the armature section 14 is longer than the length of the magnet array in the field system section 16 and is a natural number of times (integer of one or more times) the length Lc of the array of one set of the coils 18 in the armature section 14. Furthermore, the effects of the electromagnetic device 10 may be achieved when the length of the magnet array in the field system section 16 is an integer of one or more times the array length Lc of one set of the coils 18 in the armature section 14.

### Dual Halbach Array Field System

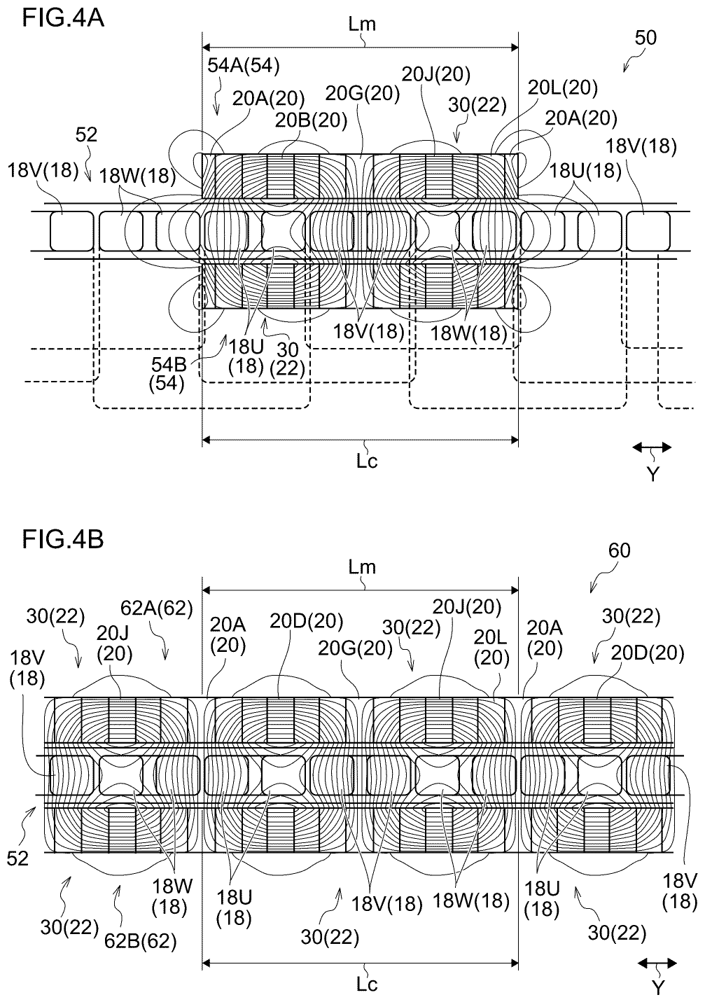

FIG. 4A is a schematic configuration diagram illustrating main parts of an electromagnetic device 50 according to the present exemplary embodiment, and FIG. 4B is a schematic configuration diagram illustrating main parts of an electromagnetic device 60 corresponding to the electromagnetic device 50.

As illustrated in FIG. 4A, the electromagnetic device 50 includes an armature section 52 disposed on a fixed body, and a field system section 54 provided on a moving body. The field system section 54 includes a field system section 54A and a field system section 54B disposed as a pair on either side of the armature section 52.

Although permanent magnet arrays 22 each including permanent magnets 20A to 20L arranged in sequence are employed in the field system sections 54A, 54B, these are illustrated as magnet arrays 30 to facilitate comparison with the electromagnetic device 60. The magnet array 30 of the field system section 54A and the magnet array 30 of the field system section 54B (referred to as the magnet arrays 30 to simplify explanation) are arranged such that their magnetic fields are strengthened on the sides thereof facing each other (the armature section 52 sides thereof).

As illustrated in FIG. 4B, the armature section 52 and a field system section 62 are provided in the electromagnetic device 60. The field system section 62 includes a field system section 62A and a field system section 62B disposed as a pair on either side of the armature section 52. The plural permanent magnet arrays 22 of the field system section 62A and the plural permanent magnet arrays 22 of the field system section 62B are arranged such that their magnetic fields are strengthened on their mutually facing sides (the armature section 52 sides thereof).

The field system section 62 of the electromagnetic device 60 accordingly configures a dual Halbach magnet array employing the plural permanent magnet arrays 22. The field system section 62 has a similar configuration to a dual Halbach array formed with plural magnet arrays 30 arrayed in each of the field system sections 62A, 62.

As illustrated in FIG. 4A and FIG. 4B, the one cycle of magnetic poles length is Lm in the field system section 54 of the electromagnetic device 50 and in the field system section 62 of the electromagnetic device 60. Moreover, in the electromagnetic devices 50, 60, the one cycle of electric angles is length Lc in each of the coil arrays 24 (one set of coils 18U, 18V, 18W) in the armature section 52.

As illustrated in FIG. 4B, in the electromagnetic device 60, the amount of flux interlinkage of magnetic flux linking with a single coil 18U from a pair of the magnet arrays 30 changes in a sine wave shape, and the back electromotive force generated in the coil 18U by the magnetic flux density distribution of one cycle of magnetic poles of the pair of magnet arrays 30 also changes in a sine wave shape.

In contrast thereto, as illustrated in FIG. 4A, in the field system section 54, magnetic flux of the permanent magnets 20A at one end of the pair of magnet arrays 30 link with the coil 18U of the coil array 24 facing the pair of magnet arrays 30, and magnetic flux of the permanent magnets 20A at the other end of the pair of magnet arrays 30 interlinkages with the coil 18U of the coil array 24 adjacent to the coil array 24 facing the pair of magnet arrays 30.

This means that, in the field system section 54, back electromotive force is generated by the magnetic flux density distribution of one cycle of magnetic poles of the pair of magnet arrays 30 in the coil 18U of the coil array 24 facing the pair of magnet arrays 30 and in the coil 18U of the coil array 24 adjacent to the coil array 24 facing the pair of magnet arrays 30.

As illustrated in FIG. 4A, in the electromagnetic device 50 the one cycle of magnetic poles length Lm of the pair of magnet arrays 30 is set the same as the one cycle of electric angles length Lc of the coil array 24 (Lm=Lc).

Moreover, in the electromagnetic device 50, for the coils 18 (18U, 18V, 18W) of each of the phases of the armature section 52, plural coils 18 of the same phase are electrically connected together in series from one side in the thrust direction to the other side thereof (illustrated by broken lines in FIG. 4A). Namely, in the electromagnetic device 50, the plural coils 18 arrayed in the thrust direction for each of the phases are connected together in series by the winding end of a given coil 18 being connected to the winding start of the next coil 18 of the same phase.

Namely, in the electromagnetic device 50, for example in the U phase, a sum of the amount of flux interlinkage from the pair of magnet arrays 30 linking to two coils 18U is configured so as to be similar to the amount of flux interlinkage from the pair of magnet arrays 34 of the electromagnetic device 60 linking to a single coil 18U. Thus in the electromagnetic device 50, a sum of the voltages generated in the two coils 18U of the magnetic flux interlinkage from the pair of magnet arrays 30 is configured so as to be equivalent to the voltage generated in a single coil 18U of magnetic flux interlinkage from the pair of magnet arrays 30 in the electromagnetic device 60.

This means that in the coil array 24 of plural phases in the electromagnetic device 50, having the one cycle of electric angles length Lc with respect to the one cycle of magnetic poles length Lm of the magnet arrays, the same current (current of the same current value) is made to flow in the coils 18 of the same phase, so that the coils 18 of the same phase can be treated as if they are electrically connected together in series, thereby enabling generation of the end effect to be suppressed. Moreover, employing the field system section 54 in the electromagnetic device 50 enables a larger output to be obtained than that of the electromagnetic device 10.

A mirror method for electric fields can also be applied (is satisfied) in magnetic fields.

This means that in an armature section 14, a ferromagnetic material employing an electrical steel sheet or the like may be disposed facing a field system section 16 so to have a prescribed spacing to the field system section 16, and a coil array 24 (coils 18) arranged between the field system section 16 and the ferromagnetic material. When doing so, the ferromagnetic material is preferably suppressed from being exposed from the coils 18 as viewed from the field system section 16 side.

This thereby enables a magnetic field similar to that of the field system section 54 to be formed between the field system section 16 where the armature section 14 is arranged and the ferromagnetic material. In the electromagnetic device formed in this manner, the field system section can have a simpler structure and lighter weight than the field system section 54 of the electromagnetic device 50, and a greater output can be obtained than that of the electromagnetic device 10.

### FIRST EXAMPLE

Next, description follows regarding a first example according to the present disclosure.

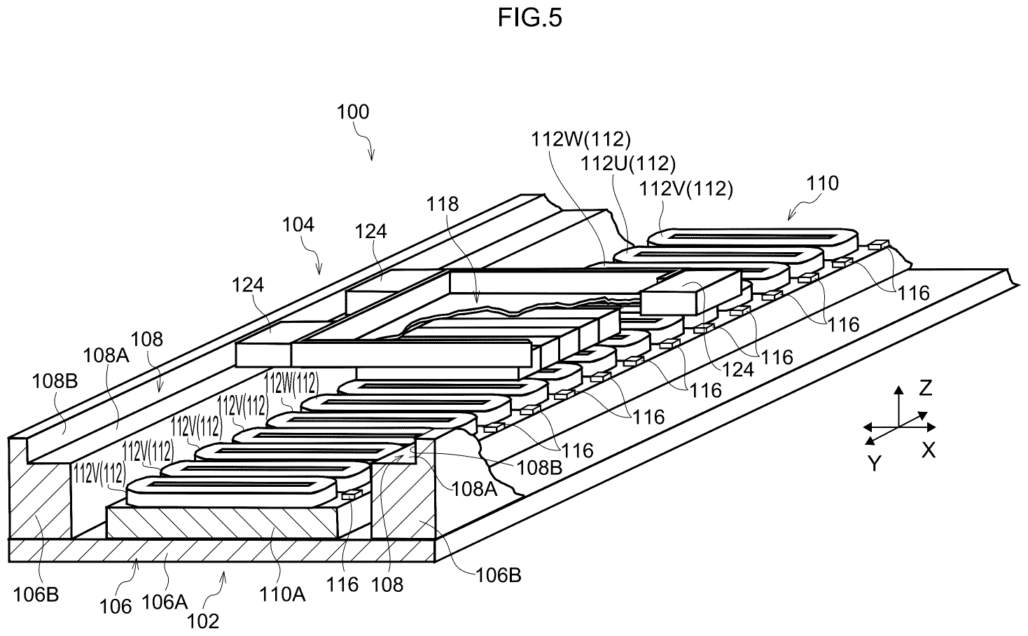

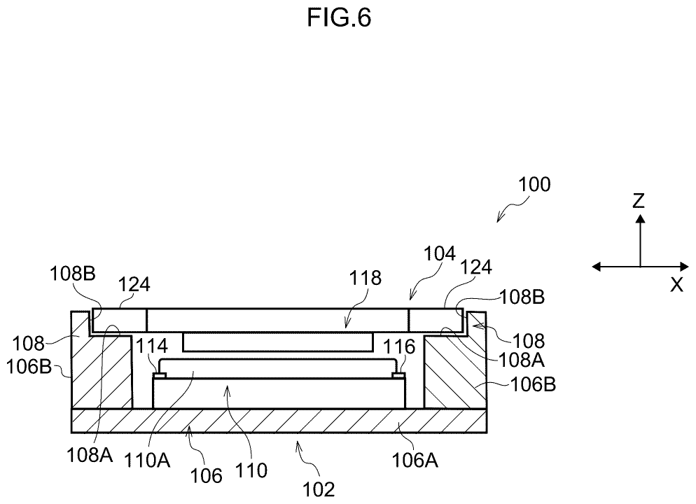

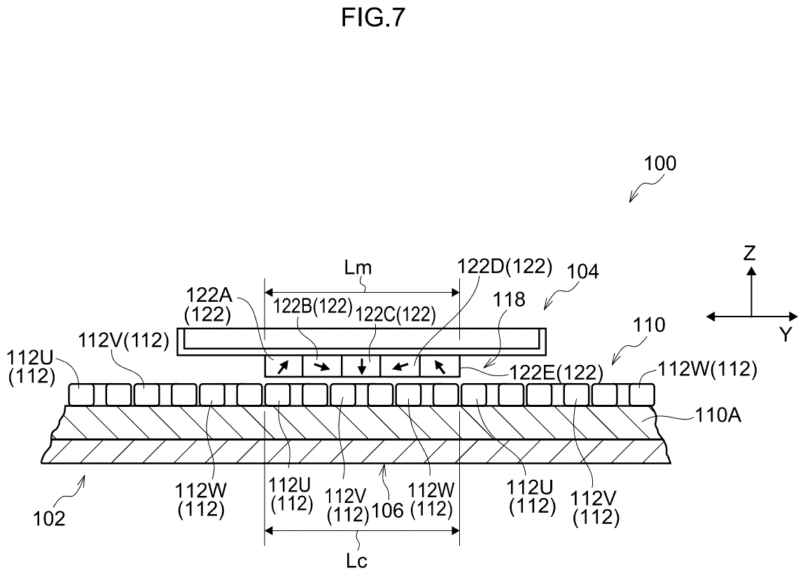

In the first example, a conveyance device 100 with a moveable-magnet linear motor applied as an electromagnetic device will be described. FIG. 5 is a perspective view illustrating main parts of the conveyance device 100, FIG. 6 is a cross-section looking along a length direction and illustrating main parts of the conveyance device 100, and FIG. 7 is a cross-section looking from a width direction outside and illustrating main parts of the conveyance device 100. Note that in the drawings, a device width direction is indicated by arrow X, a device length direction (direction along the thrust direction) is indicated by arrow Y, and a device up-down direction upper side is indicated by arrow Z.

As illustrated in FIG. 5 to FIG. 7, the conveyance device 100 includes an elongated track 102 and a conveyance platform (transport dolly) 104. The track 102 includes a base 106 serving as a fixed body and configured with an upward facing cross-section profile (substantially U-shaped profile) when viewed in the length direction, floating guides 108 that are formed at the width direction two sides of the base 106, and an armature section 110 disposed on the base 106.

The base 106 includes support sections 106B disposed as a pair at the width direction two sides of a base plate 106A, with the support sections 106B projecting upward from width direction two end portions of the base plate 106A. Moreover, the device width direction at projection leading end portions of the support sections 106B projects further upward, and the floating guides 108 are formed with substantially L-shaped profiles in cross-section at upper end portions of the support sections 106B.

A first face 108A facing upward, and a second face 108B facing toward the width direction inside, are formed to each of the floating guides 108, with the first face 108A and the second face 108B being surfaces subjected to microfabrication such that multiple non-illustrated jetting holes are opened therein. The conveyance platform 104 is disposed so as to span between the floating guides 108.

In the conveyance device 100, compressed air is supplied from a non-illustrated compressor or the like, and the supplied compressed air is ejected from the jetting holes in the first face 108A and the second face 108B. This means that in the conveyance device 100, the conveyance platform 104 spanning the floating guides 108 is floatingly supported, and the conveyance platform 104 is prevented from making contact when moved along the track 102. Note that, there is no limitation to floating on air, and rotational bodies such as tires or wheels may be employed such that the conveyance platform 104 is supported so as to be able to move through the rotational bodies by the first face 108A.

An armature section 110 is disposed between the pair of support sections 106B in the base 106. The armature section 110 includes plural armature coils (coils) 112 disposed on an elongated flat plate-shaped placement plate 110A disposed on the base plate 106A of the base 106. The plural coils 112 are arrayed at a specific spacing in the length direction of the placement plate 110A.

The placement plate 110A is also provided with plural light sensors 114 serving as position detection means, and plural Hall sensors 116 serving as position detection means and detection means (field system detection means). The light sensors 114 are arranged at a width direction one end side of each of the placement plate 110A, and the Hall sensors 116 are arranged at the width direction other end side of the placement plate 110A. The light sensors 114 and the Hall sensors 116 are each respectively attached between coils 112 adjacent in the length direction of the placement plate 110A, and plural of the light sensors 114 and the Hall sensors 116 are arranged along a movement direction of the conveyance platform 104, which is the length direction of the base 106.

The light sensors 114 detect the conveyance platform 104 on the track 102 by whether or not emitted light from non-illustrated light emitting devices has been reflected and reached photodetectors. Hall elements are employed in the Hall sensors 116, and the Hall sensors 116 detect magnetism emitted from the conveyance platform 104, and detect a field system section 118, described later, of the conveyance platform 104.

Three-phase alternating power is employed in the conveyance device 100, and U-phase coils 112U, V-phase coils 112V, and W-phase coils 112W, which are each an air-core (an air-core from a magnetic perspective), are employed as the coils 112. A coil 112U, a coil 112V, and a coil 112W configure one set in the armature section 110, with plural sets arrayed at a specific gap spacing along the length direction of the track 102.

The conveyance platform 104 includes a rectangular shaped platform frame 120. The conveyance platform 104 is arranged so as to be movable along the track 102 by the platform frame 120 being supported spanning between the pair of floating guides 108. Note that sliders 124 are arranged at four corners of the platform frame 120, and the platform frame 120 is supported floating by air ejected from the jetting holes of the floating guides 108 hitting the sliders 124.

The field system section 118 is arranged on the bottom face of the platform frame 120. Plural permanent magnets 122 are disposed in the field system section 118. In the field system section 118, a setting angle θ results from dividing one cycle of electric angles (2τ=360°) corresponding to one cycle of magnetic poles (two magnetic poles worth) by a division number n, wherein the division number n is an integer of three or more. In the field system section 118, the division number n=5 and the setting angle θ is 72° (0=72°). In the field system section 118, a one cycle of magnetic poles length Lm corresponds to the one cycle of electric angles, with five individual permanent magnets 122A to 122E arrayed facing the coils 112 in sequence in the length direction of the track 102 within a range of the length Lm.

This means that, in the conveyance device 100, the conveyance platform 104 is moved along the track 102 by thrust generated between the armature section 110 (the coils 112) and the field system section 118 (the permanent magnets 122) by each of the coils 112 being excited.

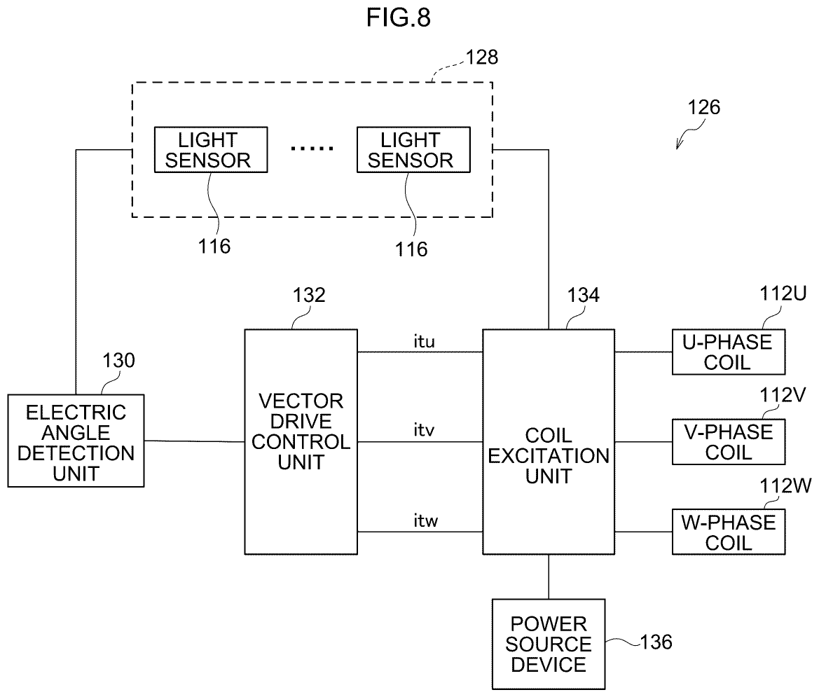

The conveyance device 100 includes a drive device 126 serving as a power supply section to excite the coils 112. FIG. 8 to FIG. 10 are schematic configuration diagrams illustrating main parts of the drive device 126.

As illustrated in FIG. 8 to FIG. 10, the drive device 126 includes a field system detector 128 that the Hall sensors 116 are connected to, and an electric angle detection unit 130 that, from an output signal of the field system detection unit 128, detects an electric angle φ of the U-phase coils 112U of the armature section 110 with respect to a field system N pole.

The drive device 126 also includes a vector control drive control unit 132. The vector control drive control unit 132 computes and outputs current target values itu, itv, itw needed in the coils 112 of each phase for speed control and position control of the field system section 118 (conveyance platform 104) based on the electric angle φ detected in the electric angle detection unit 130.

The drive device 126 includes a coil excitation unit 134. A power source device 136 to supply power to excite each of the coils 112 is connected to the coil excitation unit 134. The coil excitation unit 134 excites the coils 112U, 112V, 112W of each phase in the vicinity of the field system section 118 based on the current target values itu, itv, itw for the coils 112 of each phase, and on the output of the field system detector 128. The drive device 126 is accordingly able, for each of the phases, to flow the same current values (target current values) in each of the coils 112 of the same phase, such that the coils 112 of the same phase appear to be connected together in series.

The magnetization direction of a permanent magnet 122C at the center of the conveyance platform 104 is downward in the present exemplary embodiment. This means that by aligning a center of the permanent magnet 122C to the center position (air-core center) of the U-phase coil 112U from out of the coils 112, origin adjustment to align the origin position of a moving magnetic field generated by the coils 112 to the origin position of the conveyance platform 104 is easily performed. Note in the field system section 118 the one cycle worth of magnetic poles length Lm corresponds to the one cycle of electric angles.

In the drive device 126, for each of the U-phase, V-phase, and W-phase, the two coils 112 nearest to the two ends of the field system section 118 can be selected based on whether or not the conveyance platform 104 is present as detected by the light sensors 114 and on an accurate position of the field system section 118 as detected by the Hall sensors 116. The drive device 126 controls so as to excite the selected coils 112 with similar (the same) excitation current values (target current values).

Moreover, in cases in which the array length of the permanent magnets 122 is a length of two or more cycles worth of electric angles, the drive device 126 controls such that for each phase of the coils 112 facing the field system section 118, the coils 112 other than the coils 112 nearest to the two ends are also excited with the same excitation current values as the coils 112 nearest to the two ends for each phase.

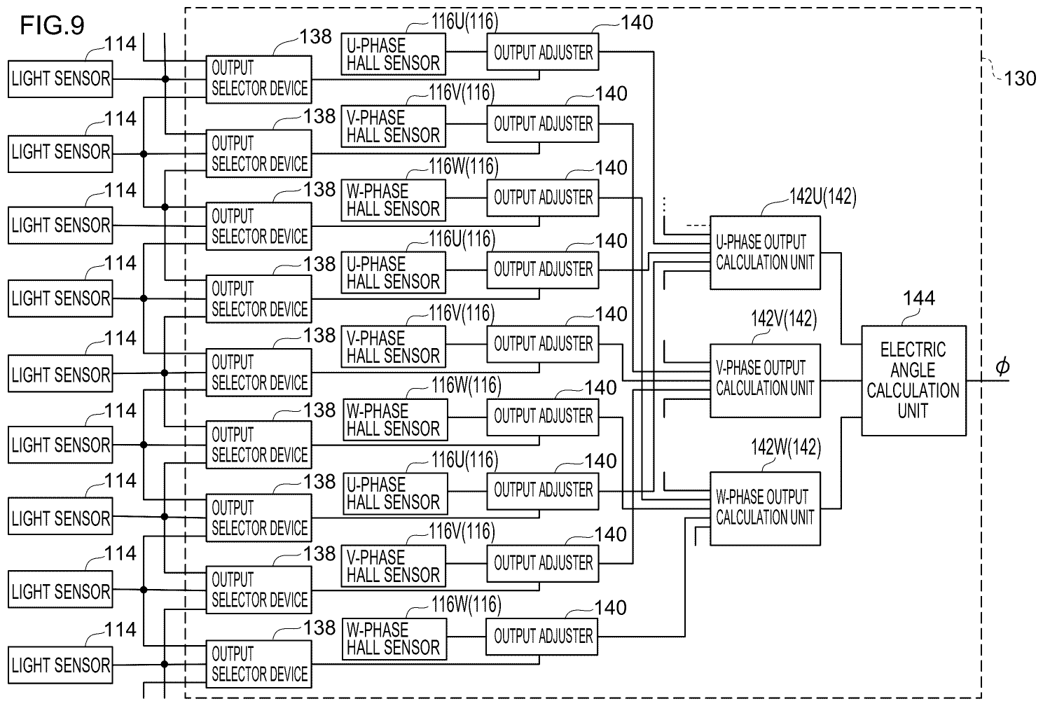

As illustrated in FIG. 9, the electric angle detection unit 130 includes plural output selectors 138, plural output adjusters 140, output calculation units 142, and an electric angle calculation unit 144. The output selectors 138 are associated with respective light sensors 114 disposed in a row in a direction at right angles to a progress direction of the conveyance platform 104 (an arrow X direction) with respect to the Hall sensors 116 and, for example, output whether or not the conveyance platform 104 has been detected by a total of three light sensors 114, these being the light sensor 114 corresponding to the U-phase Hall sensor 116U and the light sensors 114 adjacent thereto. On being input with output signals of the Hall sensors 116 (116U, 116V, 116W) for each phase and with output signals of the output selectors 138, the output adjusters 140 classify the Hall sensors 116 in a specific sequence as being a U-phase Hall sensor 116U, a V-phase Hall sensor 116V, or a W-phase Hall sensor 116W.

There is an output calculation unit 142 provided for each phase (a U-phase output calculation unit 142U, a V-phase output calculation unit 142V, and a W-phase output calculation unit 142W), and these respective output calculation units 142 compute a total of the output signals of the output adjusters 140 for each phase based on the outputs of the output selectors 138. The electric angle calculation unit 144 computes the electric angle φ based on the output signals for each phase of the phase output calculation units 142U to 142W.

The output adjusters 140 respectively output a voltage proportional to magnetic flux density produced by a specific NS pole acting as the reference for the output signals of the Hall sensors 116, proportional from a maximum negative voltage to a maximum positive voltage. Note that the output adjusters 140 output zero volts when the detected magnetic flux density is zero.

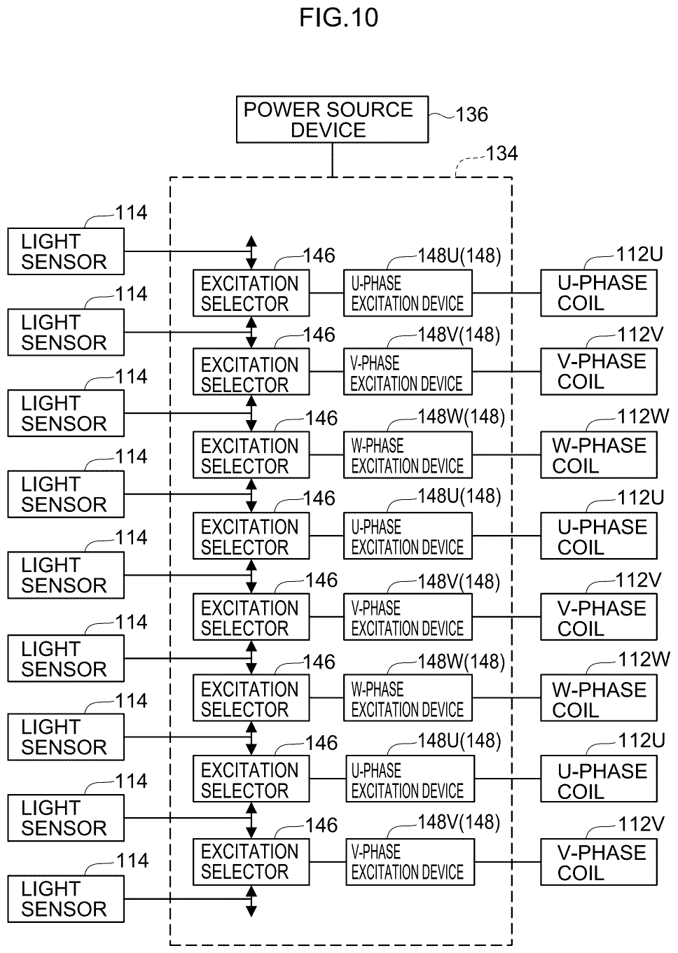

As illustrated in FIG. 10, the coil excitation unit 134 includes plural excitation selectors 146 and plural excitation devices 148. The excitation selectors 146 are each disposed on a center line of the coils 112, and output a signal as to whether or not the conveyance platform 104 has been detected by the light sensor 114 disposed at the same coil pitch and by the light sensors 114 disposed at the two sides of the coil 112 corresponding to this light sensors 114.

The excitation devices 148 are provide for each phase (an excitation device 148U, an excitation device 148V, and an excitation device 148W). When input with a signal indicating that the conveyance platform 104 has been detected by the respective light sensors 114 from the output signals of the excitation selectors 146, the excitation device 148U, 148V, 148W for the respective phase powers ON the coils 112 of the phase corresponding with an excitation current matching the respective current target value itu, itv, itw for each phase as output from the vector control drive control unit 132.

Moreover, when input with a signal indicating that the conveyance platform 104 has not been detected by the respective light sensors 114 from the output signals of the excitation selectors 146, the respective excitation device 148 stops powering ON the coils 112 of the corresponding phase. The coil excitation unit 134 is thereby able to excite only the coils 112 in the vicinity of the conveyance platform 104, and is able to suppress power consumption for exciting the coils 112.

In the conveyance device 100 configured as described above, the vector control drive control unit 132 starts vector control when the power source is switched ON and power is supplied from the power source device 136 such that the movement speed of the conveyance platform 104 achieves a pre-set speed, and each of the coils 112 is excited accordingly. In the conveyance device 100 the magnetic poles of the moving magnetic field formed by the coils 112 being excited are controlled in strength according to the movement speed of the field system section 118. This means that, in the conveyance device 100, an electromagnetic force acts on the field system section 118 from the coils 112, and the conveyance platform 104 starts floated travel. When this is performed in the conveyance device 100, a back electromotive force from the magnetic field formed by the field system section 118 accompanying movement of the conveyance platform 104 is generated on each of the coils 112.

At this time the amounts of flux interlinkage of the magnetic flux linking with two coils 112 facing the field system section 118 for each phase are sine wave shaped components having the same amplitude and shifted in phase position by 120° from each other. This means that the back electromotive force generated in the coils 112 as viewed from the three-phase power source side are similar sine wave shaped components, with the excitation currents flowing due to differences between the power source voltages and the back electromotive forces also being sine wave shaped components.

This means that between the armature section 110 and the field system section 118, an electromagnetic force acting between the magnet array having a length of an integer (positive integer) number of times the one cycle of magnetic poles length Lm, and the three-phase coils 112 facing the magnet array, can be made equivalent to electromagnetic forces that change in a sine wave shape formed by a Halbach array field system and extracted for an integer (positive integer) number of times the one cycle of magnetic poles of the electromagnetic force acting between the three-phase coils 112 disposed facing a center of the magnetic flux density distribution.

Namely, in the conveyance device 100, as long as a length along the array direction of the permanent magnets 122 in the field system section 118 is a natural number of times (integer of one or more times) the one cycle of magnetic poles length Lm, a similar current flows in the coils 112 in the vicinity of the movement direction two side ends of the permanent magnets 20 as if there was a permanent magnet 122 of the next one cycle worth of magnetic poles contiguous thereto.

Moreover, in the conveyance device 100, the drive device 126 uses the light sensors 114 and the Hall sensors 116 to detect the position of the conveyance platform 104 above the track 102, and supplies power to the coil 112 facing the conveyance platform 104 and to the coils 112 in front of and behind this coil 112 in the conveyance direction.

This means that the conveyance device 100 is configured capable of supplying power so as to flow similar current in each of the coils 112 for the same phase in the coils 112 disposed in the range linked by magnetic flux from the permanent magnets 122 of the field system section 118. Moreover, the conveyance device 100 is able to supply power so as to flow similar currents in each of the coils 112 for the same phase in the coils 112 of ranges of a half cycle of magnetic poles worth at each of the two array ends of the permanent magnets 122. This thereby enables power to be supplied effectively so as to enable the end effect to be suppressed in the conveyance device 100.

This means that, due to thrust ripple not being generated in the thrust (electromagnetic force) acting between the field system section 118 and the armature section 110 in the conveyance device 100, a smooth thrust acts on the conveyance platform 104 in the conveyance device 100, and vibration and noise are prevented from being generated.

Moreover, in the conveyance device 100, there is no load shift or damage to cargo loaded onto the conveyance platform 104 due to vibration or the like and, for example, semiconductor wafers or the like that are easily damaged by vibration or the like can be conveyed without being damaged. Moreover, thrust ripple is not generated in the conveyance device 100, and so the conveyance platform 104 can be moved to and stopped at a target position, enabling the conveyance platform 104 to be moved with high accuracy.

Furthermore, thrust ripple is not generated in the conveyance device 100, and so the conveyance platform 104 can be accelerated and decelerated at target values, enabling the conveyance device 100 to be used as an vibration test machine. Moreover, in the conveyance device 100 the total output for the Hall sensors 116 corresponding to the coils 112 of each phase in the vicinity of the field system section 118 is obtained, and so sine wave shaped voltage signals can be generated in the output calculation units 142 with phase position differences therebetween of 120° and without harmonic components contained therein. This means that in the conveyance device 100 the electric angle φ is computed with good accuracy in the electric angle calculation unit 144, and electromagnetic force that causes thrust ripple is not generated between the excited coils 112 (the armature section 110) and the permanent magnets 122 of the field system section 118.

### SECOND EXAMPLE

Next, description follows regarding a second example according to the present disclosure.

In the second example, a vibration device 200 will be described in which a moveable-magnet type of linear motor is applied as an electromagnetic device. Note that in the second example, the same reference numerals to those in the Halbach array field system, the dual Halbach array field system, and the first example are appended to functional components similar to those of the Halbach array field system, the dual Halbach array field system, and the first example, and detailed explanation thereof will be omitted.

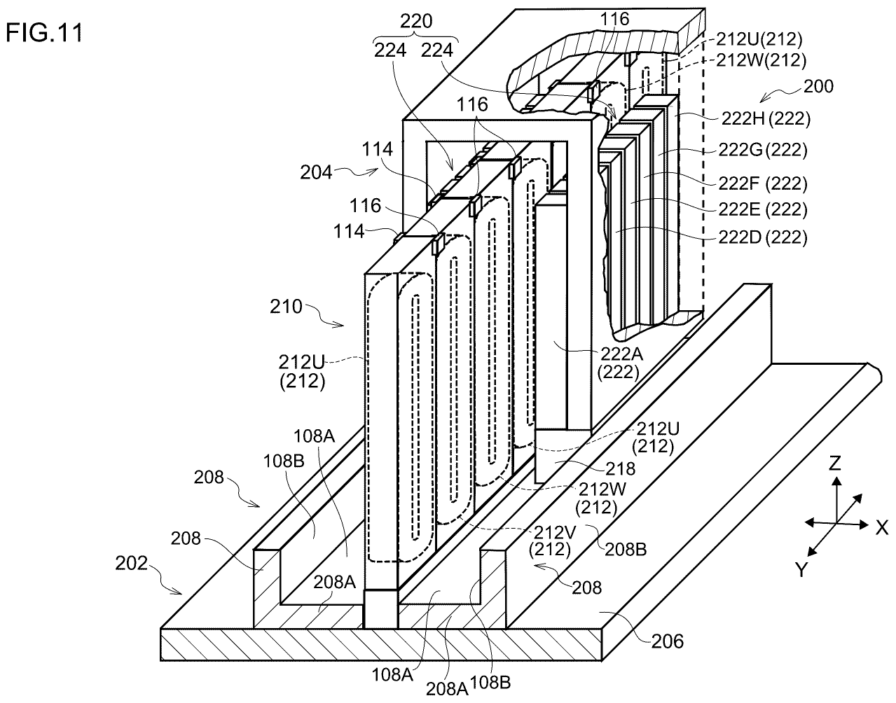

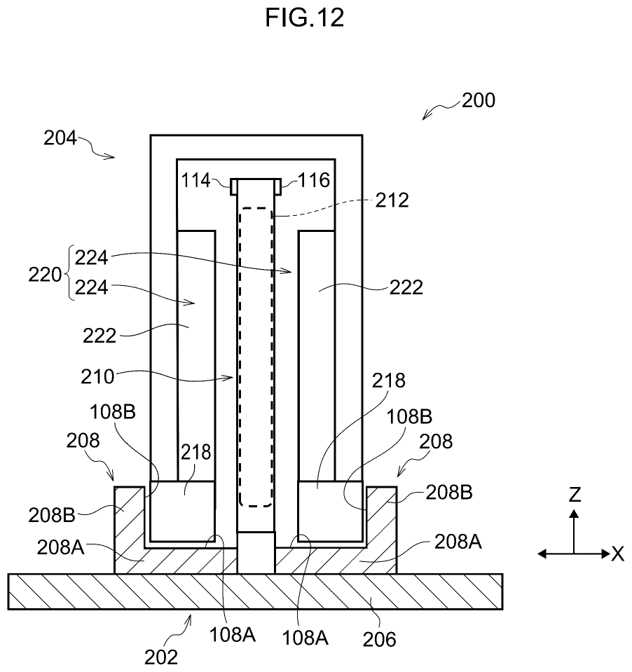

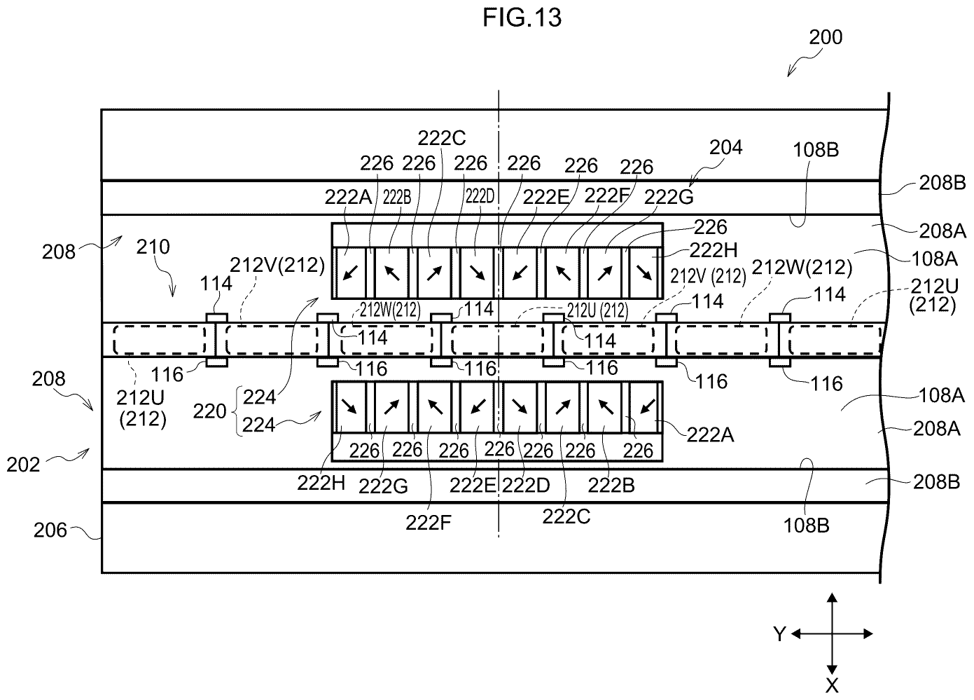

FIG. 11 is a perspective view illustrating main parts of the vibration device 200, FIG. 12 is a cross-section illustrating main parts of the vibration device 200 looking along a length direction, and FIG. 13 is a plan view illustrating main parts of the vibration device 200.

As illustrated in FIG. 11 to FIG. 13, the vibration device 200 includes a track 202, and an excitation dolly (excitation platform) 204. The track 202 includes an elongated flat plate-shaped base 206, with a left-right pair of floating guides 208 disposed on the top face of the base 206, and an armature section 210 disposed between the floating guides 208. Each of the floating guides 208 includes a guide portion 208B provided projecting upward at a width direction one end portion of a strip plate shaped base 208A, and the pair of floating guides 208 are attached above the base 206 facing each other at a specific spacing between opposite sides thereof to the guide portions 208B. The floating guides 208 each have a top face of the base 208A configuring a first face 108A and a width direction inside face of the guide portion 208B configuring a second face 108B.

The armature section 210 is disposed with plural coils 212 (U-phase coils 212U, V-phase coils 212V, and W-phase coils 212W) excited by three-phase alternating current (alternating power), with each of the coils 212 having a substantially plate shape external profile formed by molding (molded coils). In the armature section 210, the coils 212 having length directions along the up-down direction are joined together in the width direction to configure the strip plate shaped armature section 210. The armature section 210 is inserted with the lower side of the coils 212 disposed between the bases 208A of the pair of floating guides 208 on one side in the width direction. The armature section 210 is accordingly provided projecting upward above the base 206.

In the vibration device 200, an excitation dolly 204 serving as a moving body is disposed above the base 206. The excitation dolly 204 includes a non-magnetic underframe 214, with the underframe 214 formed in a substantially box shape open downward and at both track 202 length direction sides thereof. A lower portion thereof the underframe 214 is disposed between the guide portions 208B of the pair of floating guides 208 in a state in which the armature section 210 has been inserted therein from the lower side opening.

A pair of sliders 218 are disposed on the underframe 214, with the sliders 218 each having an elongated block shape. The sliders 218 are disposed attached to a lower end of the underframe 214 so as to sandwich the armature section 210, and each of the sliders 218 faces the first face 108A and the second face 108B of the floating guides 208. This means that the underframe 214 is floatingly supported by air jetted from the floating guides 208, and the excitation dolly 204 is able to move without contact along the track 202 in a state straddling the armature section 210 provided projecting upward above the base 206.

A field system section 220 is disposed inside the underframe 214. The field system section 220 is provided with permanent magnet arrays 224 that are each configured by an array of plural permanent magnets 222, with the pair of permanent magnet arrays 224 attached to the inside faces of the underframe 214 facing the armature section 210. In the field system section 220, the permanent magnet arrays 224 are set with a division number n=8 and a setting angle φ=45°. Moreover, in the field system section 220, an initial angle is set at 45° for the arrays of the permanent magnets 222 in the permanent magnet arrays 224. Eight individual permanent magnets 222A to 222H are arrayed in the pair of permanent magnet arrays 224 based on the setting angle θ and the initial angle, and are disposed inside the underframe 214 facing such that their magnetic fields reinforce each other.

Moreover, in the field system section 220, non-magnetic and non-conductive partitions 226 are fitted between adjacent permanent magnets 222 in each of the permanent magnet arrays 224. In the field system section 220, a sum of a width dimension of a permanent magnet 222 along the array direction and a width dimension (thickness dimension) of a partition 226 is configured to be ⅛ one cycle of electric angles length of the armature section 210, and the thickness dimension of one of the partitions 226 is configured as ¼ the width dimension of one of the permanent magnets 222.

Furthermore, an overall length (length in the movement direction) of the excitation dolly 204 is configured as a length of two cycles worth of electric angles formed in the permanent magnet arrays 224, with the excitation dolly 204 being shorter than a width dimension (dimension in a direction along the array direction) of an ordinary Halbach magnet array having a division number n=8 by an amount of the thickness dimension of one of the partitions 226. This means that the underframe 214 juts out from each of the two sides of each of the permanent magnet arrays 224 by ½ the thickness dimension of a partition 226.

In the armature section 210, plural light sensors 114 are arranged on one width direction side of the track 202, and plural Hall sensors 116 are arrange on the other width direction side of the track 202. The light sensors 114 are employed for detecting the position and the like of the underframe 214 (the excitation dolly 204) with respect to the armature section 210, and the Hall sensors 116 are employed for detecting the magnetic pole positions and the like of the permanent magnet arrays 224 attached to the underframe 214 with respect to the coils 212.

In the field system section 220 of the vibration device 200, the orientation of magnetic flux at a center line gap is in the width direction of the track 202 (the arrow X direction), and the center line of the excitation dolly 204, the center line of the permanent magnet arrays 224, the N pole center line of the permanent magnet array 224, and the S pole center line of the permanent magnet arrays 224 are all aligned with each other. This means that, when executing origin adjustment needed to control the position and speed of the excitation dolly 204 and to control thrust, origin adjustment is easily performed in the excitation dolly 204 merely by adjusting the center line of the excitation dolly 204 to the center position of the U-phase coils 212U of the coils 212.

Note that, in the vibration device 200, when the drive device 126 performs control of travel of the excitation dolly 204, two coils 212 nearest to the permanent magnet array 224 are selected from the coils 212 for each phase of the armature section 210, and the selected coils 212 are excited with a specific direct current. In this case, the excitation dolly 204 has a length of two cycles worth of magnetic poles of the magnetic flux density distribution of the pair of permanent magnet arrays 224 when the plural permanent magnet arrays 224 are placed in a row sandwiching the partitions 226. Selection of the coils 212, and a decision of an excitation current value of the selected coils 212, can be based on an accurate position of the permanent magnet arrays 224 computed based on the magnetic flux density distribution detected by the Hall sensors 116, and on the presence or absence of the excitation dolly 204 as detected by the light sensors 114.

Specifically, the output adjusters 140 corresponding to the Hall sensors 116 of each of the phases may be set so as to output a signal as to whether or not the excitation dolly 204 is detected by one out of the three light sensors 114 corresponding to these output, and also the excitation selectors 146 may output a signal as to whether or not whichever of the light sensors 114 at the two ends of the coils 212 is detecting the excitation dolly 204.

Moreover, whereas a ratio in the conveyance device 100 of the first example described above between the number of field poles and the number of armature slots is 2:3, a ratio between the number of field poles and the number of armature slots in the vibration device 200 is 4:3. This means that in the vibration device 200, similar drive control to that of the conveyance device 100 can be performed by changing to connecting the coils 212V and the coils 212W together in the drive device 126, and to connecting the Hall sensors 116V and 116W together.

Next, description follows regarding operation of the vibration device 200.

When the power source to the vibration device 200 is switched ON, the drive device 126 starts operation under the three-phase alternating power supplied from the power source device 136, and the excitation dolly 204 starts floated travel. In the vibration device 200, accompanying movement of the excitation dolly 204, a back electromotive force is generated in the coils 212 by the magnetic field generated by the permanent magnet arrays 224 configured as a dual Halbach array field system.

In the vibration device 200, description follows regarding the partitions 226 provided in the field system section 220. Electromagnetic force acting between the magnet arrays (Halbach field system arrays) having a length that is an integer number of times one cycle of magnetic poles and the three-phase coils facing the magnet arrays can be made equivalent to an extracted portion of electromagnetic force of an integer number of times one cycle of magnetic poles of electromagnetic force, acting between the three-phase coils 212 disposed facing the magnetic flux density distribution center, as formed by a longer Halbach array field system.

Namely, in the vibration device 200, as long as the length of the permanent magnet arrays 224 of the field system section 220 is a natural number of times (integer of one or more times) a length Lm of one cycle of the axis angles along the array direction of the permanent magnets 222, similar current flows as if there was a permanent magnet 222 contiguous to the coils 212 at the vicinity of the end portions at the movement direction two sides of the field system section 220. Moreover, in the vibration device 200 too, the drive device 126 uses the light sensors 114 and the Hall sensors 116 to detect the position of the excitation dolly 204 above the track 202 and the magnetic poles of the field system section 220, and is able to supply power effectively by supplying power to the coil 212 facing the excitation dolly 204, and to the coils 212 before and after thereof in the conveyance direction. Similar effects are thereby obtained in the vibration device 200 to those of the conveyance device 100 described above.

Moreover, in the vibration device 200, similarly to the conveyance device 100, the amounts of flux interlinkage of magnetic flux linking with two coils 212 of each phase selected for excitation are sine wave (fundamental wave) components having the same amplitude and shifted in phase position by 120° from each other, and thrust ripple is not generated in the thrust (electromagnetic force) acting between the permanent magnet arrays 224 and the coils 212. This means that in the vibration device 200, the excitation dolly 204 is able to be accelerated and decelerated at the target values thereof, and the excitation dolly 204 can be imparted with a desired excitation force while having a simple configuration for a vibration test body. Moreover, smooth thrust acts on the excitation dolly 204, and neither vibration nor noise are generated. This means that in the vibration device 200, neither load shift nor damage to cargo occurs even in a configuration to convey cargo, and the vibration device 200 can be used as a conveyance device to convey easily damaged things (cargo or the like) to a target destination.

Note that, in the present exemplary embodiments, the conveyance device 100 of the first example and the vibration device 200 of the second example have been described as examples of electromagnetic devices according to the present disclosure. However, the present disclosure can be applied to any moveable-magnet type configuration in which the field system section is moved relative to the armature section, and can be applied to a speaker or the like in which a vibration diaphragm is vibrated by moving the field system section (vibration movement thereof). Moreover, the end effect can be prevented in the electromagnetic device according to the present invention, and so application can be made to various positioning devices, and positioning can be performed at high accuracy by application to a positioning device.

Various modifications may be implemented in the electromagnetic device according to the present disclosure. The cycle length of magnetic poles in the magnet array(s) forming a Halbach array field system should be an integer (positive integer) number of times the one cycle of magnetic poles, and may be three cycle lengths or more. Furthermore, although the permanent magnets configuring the array field system (Halbach array field system) are magnetized such that the position of N poles is at the field system center on the side where the magnetic field of the Halbach array field system is reinforced, the permanent magnets may be magnetized such that a position of the N pole or the S pole is at a freely selected position of the field system. Moreover, although in the first example and the second example two individual armature coils were selected for excitation in each phase, the number of armature coil selected may be any number of two or more. Furthermore, the arrays of permanent magnets are not limited to having a straight line shape, and may have a circular arc shape or have another curved shape or the like, and although the shape of the permanent magnets is a rectangular shape, this is not a limitation to the cross-section profile of the permanent magnets.

The present disclosure as described above includes the following aspects.

<1> An electromagnetic device comprising:
a field system section in which a plurality of permanent magnets are arrayed on a moving body moved relatively in a length direction of an elongated fixed body, the plurality of permanent magnets being arrayed such that a magnetization direction is changed in sequence each time by an angle resulting from dividing one cycle of electric angles corresponding to one cycle of magnetic poles by a division number n to give an array length that is a natural number of times a length of the one cycle of electric angles along a movement direction of the moving body, wherein the division number n is any integer of three or more; and
an armature section provided to the fixed body, the armature section including a plurality of sets of armature coils that are arrayed in the length direction of the fixed body within a movement range of the moving body with one set being a number of phases worth of armature coils, and that are fed with power such that the same current is flowed in each of the armature coils of the same phase.

<2> An electromagnetic device including:
a field system section in which a plurality of permanent magnets are arrayed on a moving body moved relatively in a length direction of an elongated fixed body, the plurality of permanent magnets being arrayed such that a magnetization direction is changed in sequence each time by an angle resulting from dividing one cycle of electric angles corresponding to one cycle of magnetic poles by a division number n to give an array length that is a natural number of times a length of the one cycle of electric angles along a movement direction of the moving body, wherein the division number n is any integer of three or more; and
an armature section provided to the fixed body, the armature section including a plurality of sets of armature coils that are arrayed in the length direction of the fixed body within a movement range of the moving body with one set being a number of phases worth of armature coils; and
a power supply section that supplies power to each of the armature coils such that the same current is flowed in each of the armature coils of the same phase, when supplying power to each of the armature coils of the armature section and moving the moving body.

<3> The electromagnetic device of <1>, further including a power supply section that supplies power to each of the armature coils such that the same current is flowed in each of the armature coils of the same phase when moving the moving body.

<4> The electromagnetic device of <2> or <3>, wherein, for the armature coils in a range of the moving body linked by magnetic flux from the field system section, the power supply section supplies power such that the same current is flowed in each of the armature coils of the same phase.

<5> The electromagnetic device of any one of <2> to <4> wherein, for the armature coils in a range of a length of half a cycle worth with respect to the one cycle of magnetic poles from each of two ends of the array of permanent magnets, the power supply section supplies power such that the same current is flowed in each of the armature coils of the same phase.

<6> The electromagnetic device of <4> or <5>, further including a detection means, provided to the fixed body facing the field system section, that detects magnetic flux to detect the permanent magnet array, and
wherein the power supply section supplies power to the armature coils according to a detection result of the detection means.

<7> The electromagnetic device of any one of <1> to <6>, wherein a length Lc of an array of one set of the armature coils is configured as a natural number of times a length Lm of the one cycle of magnetic poles of the permanent magnets.

<8> The electromagnetic device of any one of <1> to <6>, wherein a length of the array of the armature coils in the armature section is configured as a natural number of times a length Lc of the array of the armature coils of one set.

<9> The electromagnetic device of any one of <1> to <8>, wherein: the field system section includes a first magnet array and a second magnet array each arrayed with the plural permanent magnets, and the first magnet array and the second magnet array arranged facing each other such that magnetic fields formed by each other are reinforced with the armature coils interposed therebetween.

<10> The electromagnetic device of any one of <1> to <8>, wherein a ferromagnetic material is disposed in the armature section in an array range of the plural armature coils, at an opposite side of the armature coils to the field system section.

Moreover, the entire content of the disclosure of Japanese Patent Application No. 2022-087258, is incorporated by reference in the present specification. All publications, patent applications and technical standards mentioned in the present specification are incorporated by reference in the present specification to the same extent as if each individual publication, patent application, or technical standard was specifically and individually indicated to be incorporated by reference.

1. An electromagnetic device comprising:
a field system section in which a plurality of permanent magnets are arrayed on a moving body moved relatively in a length direction of an elongated fixed body, the plurality of permanent magnets being arrayed such that a magnetization direction is changed in sequence each time by an angle resulting from dividing one cycle of electric angles corresponding to one cycle of magnetic poles by a division number n to give an array length that is a natural number of times a length of the one cycle of electric angles along a movement direction of the moving body, wherein the division number n is any integer of three or more and the magnetization direction at both ends is the same; and
an armature section provided to the fixed body, the armature section including a plurality of sets of armature coils that are arrayed in the length direction of the fixed body within a movement range of the moving body with one set being a number of phases worth of armature coils, and that are fed with power such that the same current is flowed in each of the armature coils of the same phase,
wherein, for cross-section profiles of the permanent magnets, when the field system section is sectioned along a direction of arraying the permanent magnets, permanent magnets of a center section excluding both ends in the array direction have the same cross-section profiles to each other, and a cross-section profile when one and another of the permanent magnets at the two array direction ends are made contiguous to each other is the same as the cross-section profile of each of the permanent magnets of the center section.

2. An electromagnetic device comprising:
a field system section in which a plurality of permanent magnets are arrayed on a moving body moved relatively in a length direction of an elongated fixed body, the plurality of permanent magnets being arrayed such that a magnetization direction is changed in sequence each time by an angle resulting from dividing one cycle of electric angles corresponding to one cycle of magnetic poles by a division number n to give an array length that is a natural number of times a length of the one cycle of electric angles along a movement direction of the moving body, wherein the division number n is any integer of three or more and the magnetization direction at both ends is the same;
an armature section provided to the fixed body, the armature section including a plurality of sets of armature coils that are arrayed in the length direction of the fixed body within a movement range of the moving body with one set being a number of phases worth of armature coils; and
a power supply section that supplies power to each of the armature coils such that the same current is flowed in each of the armature coils of the same phase, when supplying power to each of the armature coils of the armature section and moving the moving body,
wherein, for cross-section profiles of the permanent magnets, when the field system section is sectioned along a direction of arraying the permanent magnets, permanent magnets of a center section excluding both ends in the array direction have the same cross-section profile to each other, and a cross-section profile when one and another of the permanent magnets at the two array direction ends are made contiguous to each other is the same as the cross-section profile of each of the permanent magnets of the center section.

3. The electromagnetic device of claim 1, further comprising a power supply section that supplies power to each of the armature coils such that the same current is flowed in each of the armature coils of the same phase when moving the moving body.

4. The electromagnetic device of claim 2, wherein, for the armature coils in a range of the moving body linked by magnetic flux from the field system section, the power supply section supplies power such that the same current is flowed in each of the armature coils of the same phase.

5. The electromagnetic device of claim 2 wherein, for the armature coils in a range of a length of half a cycle worth with respect to the one cycle of magnetic poles from each of two ends of the array of permanent magnets, the power supply section supplies power such that the same current is flowed in each of the armature coils of the same phase.

6. The electromagnetic device of claim 4, further including a detection means, provided to the fixed body facing the field system section, that detects magnetic flux to detect the permanent magnet array, and
wherein the power supply section supplies power to the armature coils according to a detection result of the detection means.

7. The electromagnetic device of claim 1, wherein a length Lc of an array of one set of the armature coils is configured as a natural number of times a length Lm of the one cycle of magnetic poles of the permanent magnets.

8. The electromagnetic device of claim 1, wherein a length of the array of the armature coils in the armature section is configured as a natural number of times a length Lc of the array of the armature coils of one set.

9. The electromagnetic device of claim 1, wherein:
the field system section includes a first magnet array and a second magnet array each arrayed with the plurality of permanent magnets, and
the first magnet array and the second magnet array arranged facing each other such that magnetic fields formed by each other are reinforced with the armature coils interposed therebetween.

10. The electromagnetic device of claim 1, wherein a ferromagnetic material is disposed in the armature section in an array range of the plurality of armature coils, at an opposite side of the armature coils to the field system section.
